(19) United States
(12) Patent Application Publication
(10) Pub. No.: US 2017/0071022 A1
(43) Pub. Date: Mar. 9, 2017

(54) SESSION MANAGEMENT BETWEEN DIFFERENT WIRELESS LOCAL AREA NETWORKS

(71) Applicant: QUALCOMM Incorporated, San Diego, CA (US)

(72) Inventors: Hemanth SAMPATH, San Diego, CA (US); Peerapol TINNAKORNSRISUPHAP, San Diego, CA (US); Qi XUE, San Diego, CA (US); Bibhu Prasad MOHANTY, San Diego, CA (US)

(21) Appl. No.: 15/256,907

(22) Filed: Sep. 6, 2016

Related U.S. Application Data
(60) Provisional application No. 62/215,705, filed on Sep. 8, 2015.

(51) Int. Cl. H04W 76/02; H04W 48/06; H04W 48/18

(52) U.S. Cl. CPC H04W 76/025; H04W 48/18; H04W 48/06; H04W 84/12

(57) ABSTRACT

Certain aspects of the present disclosure generally relate to wireless communications and, more particularly, to session management between a wireless wide area network (WWAN) and a wireless local area network (WLAN). An exemplary method includes exchanging messages in a first wireless local area network (WLAN) during a communication session, maintaining information for the communication session, enabling a second WLAN for the communication session based on detection of at least one first condition, and utilizing the information for the communication session via the second WLAN.

### CLAIM OF PRIORITY UNDER 35 U.S.C. §119

The present application for patent claims benefit of U.S. Provisional Patent Application Ser. No. 62/215,705, filed Sep. 8, 2015, assigned to the assignee hereof and hereby expressly incorporated by reference herein.

### BACKGROUND

Field of the Disclosure

Certain aspects of the present disclosure generally relate to wireless communications and, more particularly, to session management between different wireless local area networks (WLANs).

Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various techniques are being developed. One such technique is to utilize a wireless local area network (WLAN), such as an Institute of Electrical and Electronics Engineers (IEEE) 802.11ah wireless network, for some communications to a device, and a different WLAN (e.g., 2.4/5 GHz). Thus, there is a desire to develop techniques for session management between WLANs.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide an apparatus for wireless communications. The apparatus generally includes at least one interface configured to exchange messages, via a first receiver, in a first WLAN during a communication session; and a processing system configured to: maintain information for the communication session, enable a second WLAN for the communication session based on detection of at least one first condition, and utilize the information for the communication session via the second WLAN.

Certain aspects of the present disclosure provide a method for wireless communications. The method generally includes exchanging messages, via a first receiver, in a first WLAN during a communication session; maintaining information for the communication session; enabling a second WLAN for the communication session based on detection of at least one first condition; and utilizing the information for the communication session via the second WLAN.

Certain aspects of the present disclosure provide an apparatus for wireless communications. The method generally includes means for exchanging messages, via a first receiver, in a first WLAN during a communication session; means for maintaining information for the communication session; means for enabling a second WLAN for the communication session based on detection of at least one first condition; and means for utilizing the information for the communication session via the second WLAN.

Certain aspects of the present disclosure provide a computer readable medium. The computer readable medium generally includes computer executable code (e.g., instructions) stored thereon for: exchanging messages, via a first receiver, in a first WLAN during a communication session; maintaining information for the communication session; enabling a second WLAN for the communication session based on detection of at least one first condition; and utilizing the information for the communication session via the second WLAN.

Certain aspects of the present disclosure provide a wireless station. The wireless station generally includes a first receiver configured to exchange messages in a first wireless local area network (WLAN) during a communication session; and a processing system configured to: maintain information for the communication session, enable a second WLAN for the communication session based on detection of at least one first condition, and utilize the information for the communication session via the second WLAN.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents. Certain aspects also provide various methods, apparatuses, and computer program products capable of performing operations corresponding to those described above.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of an example wireless communications network, in accordance with certain aspects of the present disclosure.

FIG. 2 illustrates a block diagram of an example access point (AP) and user terminals (UTs), in accordance with certain aspects of the present disclosure.

FIG. 3 illustrates a block diagram of an example wireless node, in accordance with certain aspects of the present disclosure.

FIG. 4 illustrates example architecture for a device configured to communicate via one or more wireless local area networks (WLANs) and a wireless wide area network (WWAN), in accordance with certain aspects of the present disclosure.

FIG. 5 illustrates an example timing diagram for a station operating in accordance with certain aspects of the present disclosure.

FIG. 6 sets forth example operations for wireless communications, in accordance with certain aspects of the present disclosure.

FIG. 6A illustrates example means capable of performing the operations set forth in FIG. 6.

FIG. 7 illustrates example architecture for a device configured to communicate via one or more WLANs and a WWAN, in accordance with certain aspects of the present disclosure.

FIG. 8 illustrates example architecture for a device configured to communicate via one or more WLANs and a WWAN, in accordance with certain aspects of the present disclosure.

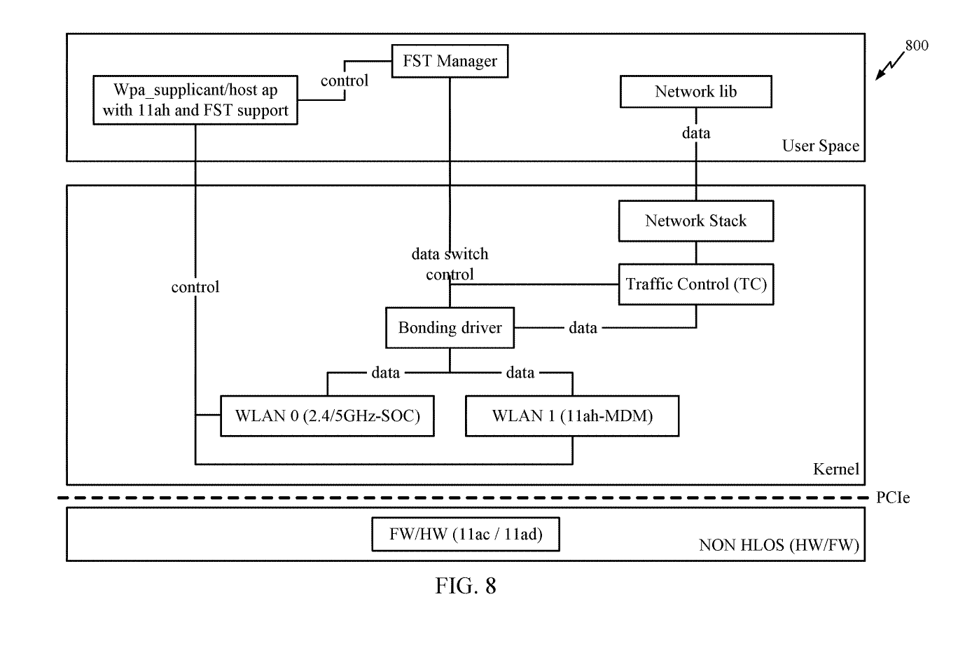

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Demand for improved (increased) data transmission rates of wireless networks has led to the development of devices capable of communicating using both wireless wide area networks (WWANs) (e.g., a long term evolution (LTE) network) and wireless local area networks (WLANs) (e.g., a Wi-Fi network). Wireless communications devices (e.g., access points and non access-point stations) capable of communicating with both WWANs and WLANs may monitor for paging messages in both a WWAN and one or more WLANs. Such a device may consume more power in monitoring for paging messages in multiple networks than it would in monitoring for paging messages in a single network.

A station (STA) operating according to the IEEE 802.11ah wireless networking standard may enter a low-power state (e.g., a deep-sleep mode), wherein the STA powers off one or more components, including receiver components, and does not transmit or receive until the STA wakes up. Such a STA may associate to an access point (AP) of a WLAN and be configured to wake periodically to listen for paging messages from the AP and/or transmit data to the AP. When the STA is preparing to enter the low-power state, the STA and the AP may negotiate a target wake time (TWT) when the STA will wake up. The TWT may occur periodically. By negotiating the TWT, the STA is configured to wake up periodically and listen for paging messages, and the AP is configured with times to page the STA, if the AP has data to send to the STA. If data for the STA arrives at the AP while the STA is in the low-power state, the AP may buffer the data until the next TWT has occurred, and then send a paging message to the STA to notify the STA that the STA should exit the low-power state (e.g., wake up). After the STA has exited the low-power state, the AP may transmit the buffered data to the STA.

According to aspects of the present disclosure, session management may be performed between a modem and WLAN. For example, the techniques described herein may be performed to transfer a communications session between an IEEE 802.11ah device (e.g., modem chip) and a 2.4/5 GHz WLAN device (e.g., located a system on a chip or SoC), for example, based on conditions such as bandwidth or signal strength. IP continuity may be maintained across the WLANs via, for example, maintaining a same Virtual MAC-ID or a same Client-ID.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

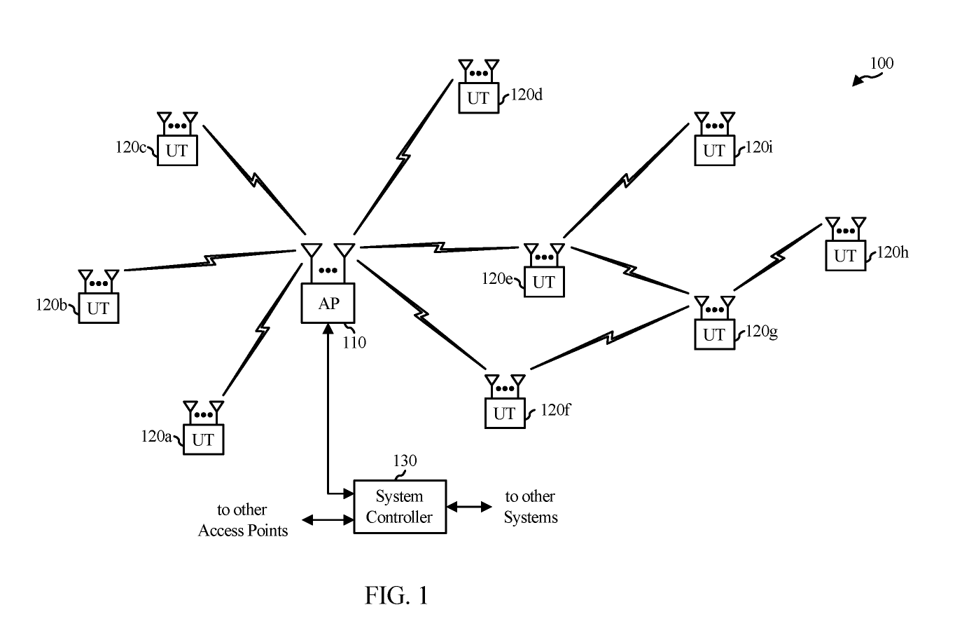

FIG. 1 illustrates a multiple-access multiple-input multiple-output (MIMO) system 100 with access points and user terminals in which aspects of the present disclosure may be practiced. For example, the techniques described herein may be used for a user terminals 120 to transfer a communications session between WLANs, for example, between a modem supporting IEEE 802.11ah WLAN and a 2.4/5 GHz WLAN system-on-chip (SoC).

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 may couple to and provide coordination and control for the access point.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) portion of MIMO, while a set of K user terminals represent the multiple-output (MO) portion of MIMO. Conversely, for uplink MIMO transmissions, the set of K user terminals represent the MI portion, while the Nₐₚ antennas of the access point 110 represent the MO portion. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

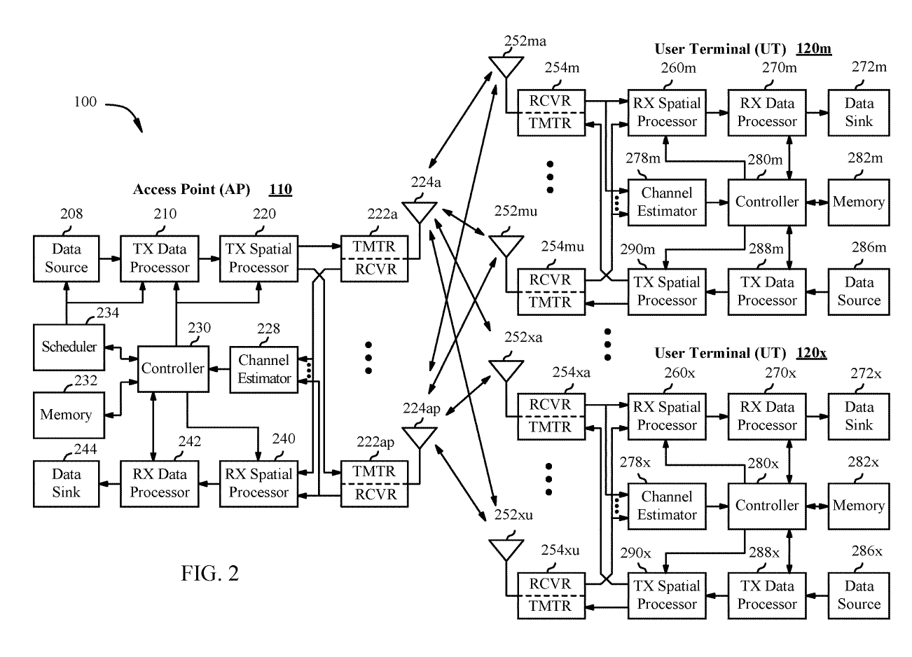

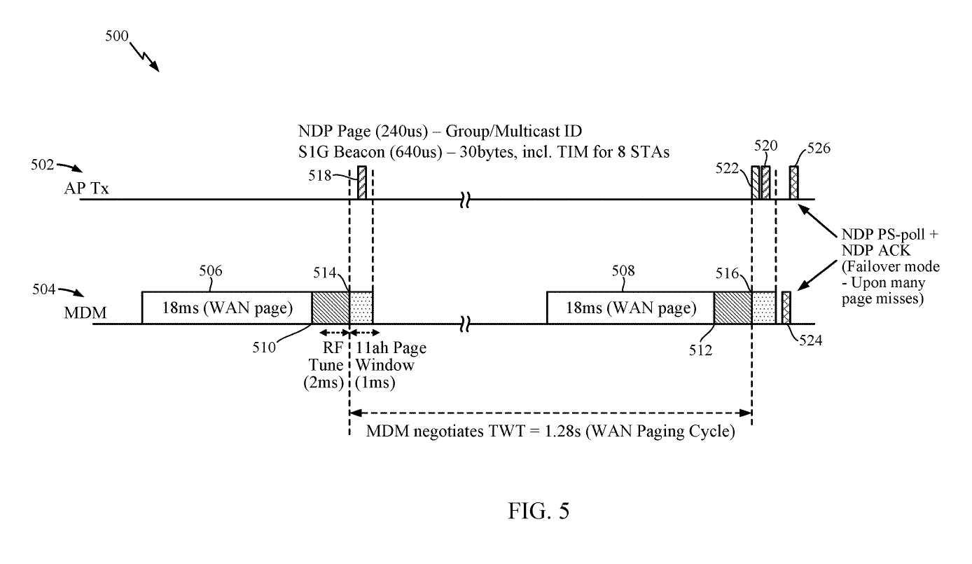

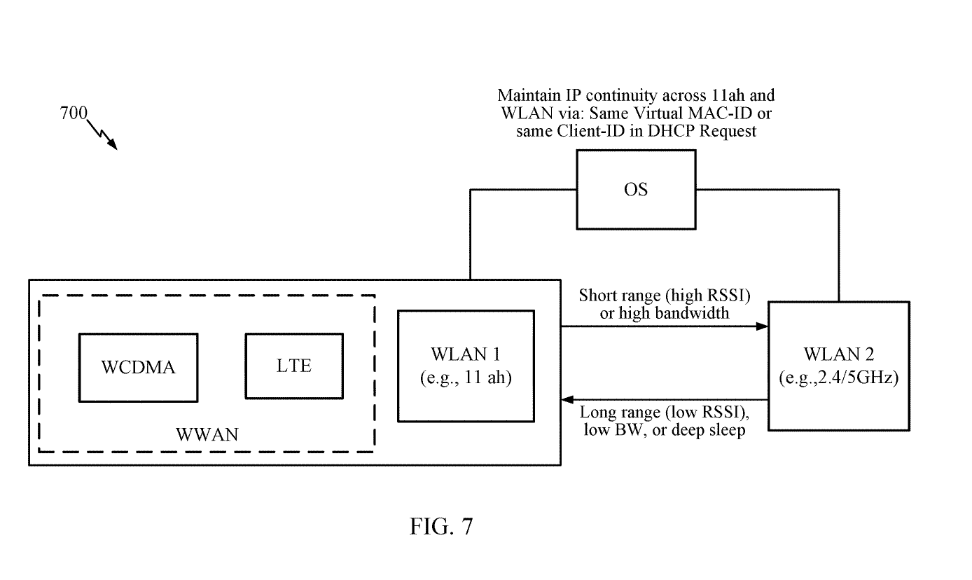

FIG. 2 illustrates a block diagram of access point 110 and two user terminals 120m and 120x in MIMO system 100 that may be examples of the access point 110 and user terminals 120 described above with reference to FIG. 1 and capable of performing the techniques described herein. The various processors shown in FIG. 2 may be configured to perform (or direct a device to perform) various methods described herein, for example, the operations 500 and 700 described in association with FIGS. 5 and 7.

FIG. 2 illustrates a block diagram of access point 110 and two user terminals 120m and 120x in MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ user terminals simultaneously transmit on the uplink, while N_{dn} user terminals simultaneously transmit on the downlink. Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the Nₐₚ downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or a controller 280 for further processing.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix Hdn,m for that user terminal. Controller 230 derives the spatial filter matrix for the access point based on the effective uplink channel response matrix Hup,eff. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

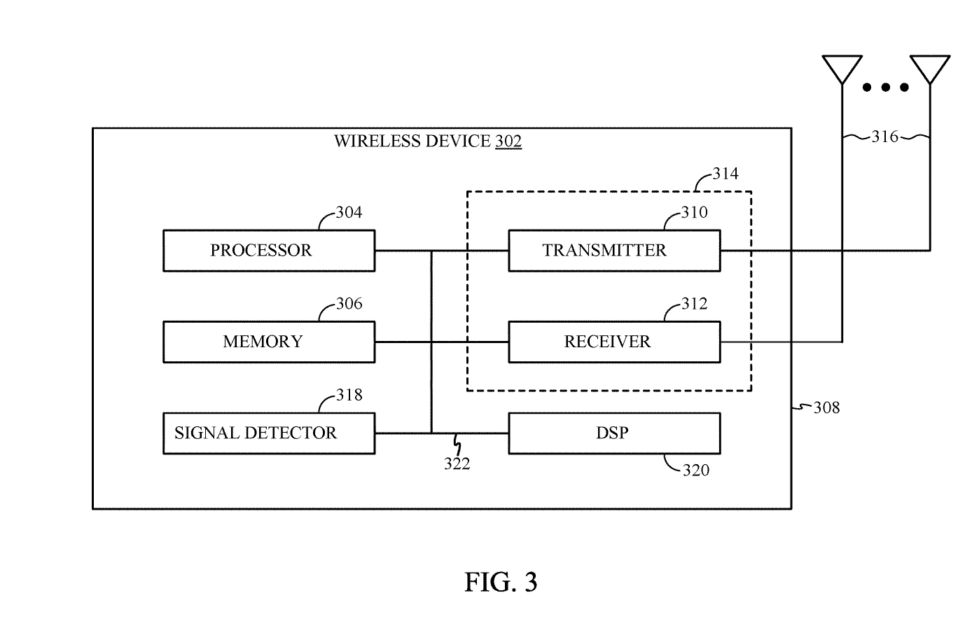

FIG. 3 illustrates example components that may be utilized in AP 110 and/or UT 120 to implement aspects of the present disclosure. For example, the transmitter 310, antenna(s) 316, processor 304, and/or DSP 320 may be used to practice aspects of the present disclosure implemented by an AP or UT, such as operations 500 and/or operations 700 described in association with FIGS. 5 and 7, respectively, below. Further, the receiver 312, antenna(s) 316, processor 304, and/or the DSP 320 may be used to practice aspects of the present disclosure implemented by an AP or UT, such as operations 500 and/or operations 700 described in association with FIGS. 5 and 7, respectively, below. The wireless node (e.g., wireless device) 302 may be an access point 110 or a user terminal 120.

The wireless node (e.g., wireless device) 302 may include a processor 304 which controls operation of the wireless node 302. The processor 304 may also be referred to as a central processing unit (CPU). The processor 304 may control the wireless node 302 in executing the various methods described herein, for example, the operations 500 and 700 described in association with FIGS. 5 and 7. Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein, for example, the operations 500 and/or operations 700 described in association with FIGS. 5 and 7, respectively, below.

The wireless node 302 may also include a housing 308 that may include a transmitter 310 and a receiver 312 to allow transmission and reception of data between the wireless node 302 and a remote node. The transmitter 310 and receiver 312 may be combined into a transceiver 314. A single transmit antenna or a plurality of transmit antennas 316 may be attached to the housing 308 and electrically coupled to the transceiver 314. The wireless node 302 may also include (not shown) multiple transmitters, multiple receivers, and multiple transceivers.

The wireless node 302 may use multiple transmitters, multiple receivers, and/or multiple transceivers in communicating with a WWAN and one or more WLANs. Additionally or alternatively, the wireless node 302 may communicate with a WWAN via a single transmitter 310, a single receiver 312, and/or a single transceiver 314 and retune the transmitter 310, receiver 312, and/or transceiver 314 (tune away from the WWAN) to communicate with one or more WLANs.

The wireless node 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless node 302 may also include a digital signal processor (DSP) 320 for use in processing signals.

The various components of the wireless node 302 may be coupled together by a bus system 322, which may include a power bus, a control signal bus, and a status signal bus in addition to a data bus.

In general, an AP and STA may perform similar (e.g., symmetric or complementary) operations. Therefore, for many of the techniques described herein, an AP or STA may perform similar operations. To that end, the following description will sometimes refer to an “AP/STA” to reflect that an operation may be performed by either. Although, it should be understood that even if only “AP” or “STA” is used, it does not mean a corresponding operation or mechanism is limited to that type of device.

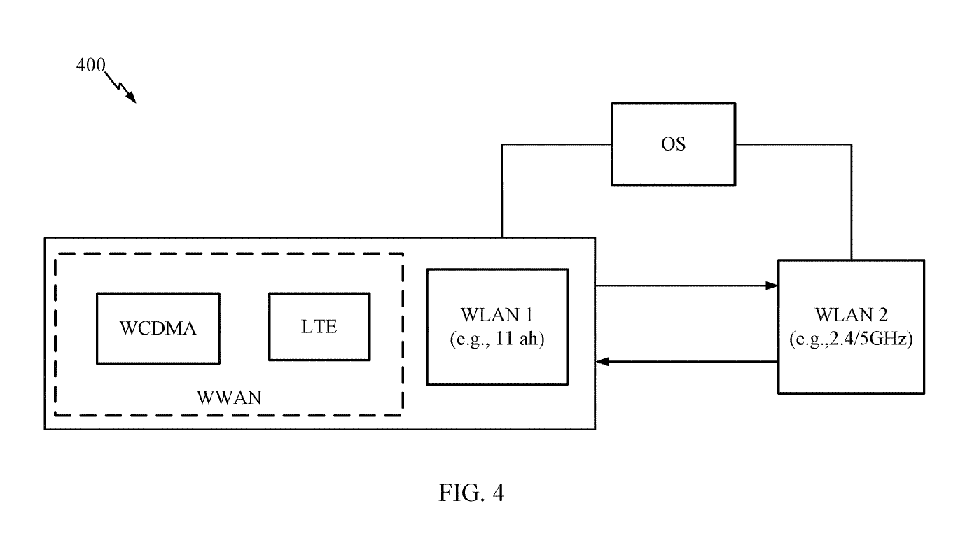

FIG. 4 illustrates example architecture 400 for a device configured to communicate via one or more wireless local area networks (WLANs) and a wireless wide area network (WWAN), in accordance with certain aspects of the present disclosure. As shown in FIG. 4, the device may include a WWAN modem (MDM) which may also support WLAN, such as WLAN 1 (e.g., for IEEE 802.11ah communications), an operating system (e.g., IOS, Android, etc.), and an a WLAN AP (e.g., a system on chip (SoC)) for communicating with a WLAN 2 (e.g., a 2.4/5 GHz WLAN).

As described above, a station (STA) operating according to one standard e.g., (the IEEE 802.11 ah wireless networking standard) may enter a low-power state (e.g., a deep-sleep mode), wherein the STA powers off one or more components, including receiver components, and does not transmit or receive until the STA wakes up. Such a STA may negotiate, with another STA (for example the AP of a WLAN), a target wake time (TWT) when the STA will wake up. The (next) TWT may be indicated (from or to the STA) explicitly every time the STA interacts with the other STA or may occur periodically and the parameters of the TWT schedules may be negotiated in advance. By negotiating the TWT, the STA is configured to wake up periodically at the scheduled TWTs and either listen for paging messages sent by the AP or transmit a polling frame to the AP, and similarly the AP is configured such that it transmits paging frame(s) to the STA or to receive a polling frame from the STA. During this frame exchange, the communicating devices may communicate to each other whether they have data to send to each other. In certain embodiments the STAs exchange other information with each other (e.g., to switch frequency bands and/or communication technologies). In the embodiment wherein the AP indicates data availability, if data for the STA arrives at the AP while the STA is in the low-power state, the AP may buffer the data until the next TWT has occurred, and then send a paging message to the STA to notify the STA that the STA should exit the low-power state (e.g., wake up). After the STA has exited the low-power state, the AP may transmit the buffered data to the STA. While the example is related to one STA in particular, one skilled in the art may appreciate that this scheduled procedure may be negotiated and used by and/or with one or more STAs.

According to aspects of the present disclosure, a STA may negotiate with an AP to align a TWT with wakeup periods (e.g., wake times in a discontinuous reception (DRX) cycle) of a WWAN. The TWT may be aligned with a WWAN wakeup period by occurring shortly before, during, or shortly after a wakeup period of the WWAN. For example, a STA may be configured (e.g., in a DRX configuration received from a WWAN) to monitor for paging messages from a WWAN every 1.28 seconds, and the STA may request, from a WLAN AP, a TWT that occurs every 1.28 seconds and shortly after each paging-cycle of the WWAN. A STA that has negotiated a TWT aligned with wakeup periods of a WWAN may use some receiver components for monitoring for paging messages from the WWAN and from the AP. By negotiating a TWT aligned with wakeup periods of the WWAN, the STA may power on receiver components continuously for the TWT and the WWAN wakeup period, thus avoiding powering on the components for two separated periods of a TWT and a WWAN wakeup period and saving some power, when compared with waking up at two separated periods.

According to some aspects of the present disclosure, a STA may use one receiver for monitoring for paging messages from a WLAN and a WWAN by retuning the receiver from a frequency band used for paging messages of the WWAN to a frequency band used for paging messages of the WLAN. A STA monitoring for pages in a WLAN with a same receiver the STA uses for monitoring in a WWAN may keep the receiver powered up for a time period longer than a paging period of the WWAN. For example, a STA may use a receiver to monitor for paging messages from an LTE cellular network, and then retune the receiver to a frequency in a 900 MHz frequency band to receive paging messages from an IEEE 802.11 ah WLAN. In the example, the STA may power up the receiver for eighteen milliseconds to monitor for pages from the LTE network and keep the receiver powered up for an additional three milliseconds to monitor for pages from the IEEE 802.11 ah WLAN. Still in the example, the STA may use two milliseconds of the three milliseconds in retuning the receiver from the LTE frequency band to the IEEE 802.11ah WLAN frequency band and the remaining one millisecond monitoring for IEEE 802.11ah WLAN paging messages.

According to aspects of the present disclosure, a STA using a single receiver to receive WWAN pages and IEEE 802.11 ah WLAN pages and operating according to the present disclosure may consume less than half of the power that a STA using a separate receiver to receive IEEE 802.11n pages consumes.

In some cases, a STA may send a poll frame (e.g., a PS-Poll, and NDP PS-Poll, an unscheduled automatic power-save delivery (u-APSD) trigger frame) in the first WLAN during the at least one of the one or more first wake up periods. In these cases, the monitoring for paging messages in the first WLAN described in block 408 above may comprise monitoring for a reply to the poll frame sent by the STA.

FIG. 5 illustrates an exemplary timeline 500 showing operations of an AP of a WLAN and a STA (e.g., MDM) operating in accordance with aspects of the present disclosure. Operations of the AP are shown at 502, while operations of the STA are shown at 504.

At 506 and 508, the STA powers up (e.g., activates) a receiver to monitor for paging messages from a WWAN. At 510 and 512, the end of the WWAN paging-cycle window ends, and the STA leaves the receiver powered up while retuning the receiver to monitor for paging messages from the WLAN. At 514 and 516, the STA has completed retuning the receiver and monitors for paging messages from the WLAN AP. The STA has previously negotiated (not shown) the time periods 514 and 516 with the AP as time periods for the STA to monitor for paging messages from the AP.

At 518 and 520, the AP transmits a paging message for the STA. As described above, the paging message from the AP may comprise an NDP paging frame, possibly using an AID, group ID, and/or multicast ID to indicate accordingly whether the paging message is intended for one STA, a group of STAs and so on. The frame can also indicate that the paging message is intended to all STAs that are scheduled at that particular duration of time Also as described above, the paging message may comprise a beacon (e.g., a Beacon frame, S1G Beacon, DMG beacon), a TIM Broadcast frame, a null data packet (NDP), etc. In certain embodiments the paging message contains information regarding the type of traffic (voice, video, best effort, etc.), the amount of traffic (e.g., a quantity octets), quality of service (QoS) requirements (e.g., min, max, average allowed delay for delivery), etc., the AP has buffered for the one or more STAs for which the paging message is intended, and also specifics related to the technology (LTE (and related category), HSUPA, IEEE802.11a/b/g/n/ac,) and other parameters (e.g., frequency, bandwidth (BW), rates, estimated transmit times, etc.) that are planned to be used by the AP for delivery of the traffic.

FIG. 5 also illustrates exemplary operations by the AP and STA if the STA misses too many paging messages, as discussed above. In some cases, an AP may not send a paging message at 520, instead sending a paging message at 522 for a STA before the STA has begun monitoring for the paging message at 516. As previously described, a STA that misses too many paging messages may send a polling message to the AP. While an NDP PS-Poll is shown at 524, other types of frames may be used, such as a PS-Poll frame, trigger frame, or any suitable frame.

An AP receiving the NDP PS-poll may respond with an acknowledgement frame (e.g., an NDP PS-Poll-ACK), as shown at 526. Alternatively, upon reception of a polling message from a STA, the AP may also respond with a paging message which contains information for the one or more other STAs that were scheduled to wake up at the same time period. For example the paging message (e.g., a Beacon frame with a TIM element indicating the presence of DL BU available at the AP for 4 STAs) may be sent shortly after the reception of the polling message, to indicate the information, not only to the polling STA but also to the other STAs. By sending a beacon frame to multiple STAs, the AP may avoid having the remaining STAs poll the AP as well.

In certain embodiments, the failure of reception of a paging message from the AP at a scheduled time (TWT) may be an indication for the (one or more) STA that the STA and the AP are losing synchronization. For example, the time synchronization function of the AP and that of the STA may be out of synch (one of the time synchronization functions is slower than the other). In this case, one or more of the STAs may then negotiate a new wakeup time (TWT) aligned with future WWAN paging-cycles. In order to maintain synchronization, one or more of the STAs may send these requests of new wake up times periodically (e.g., every 10 paging cycles). The STAs may also determine the periodicity of these requests based on a determination of the average number of STAs being served by that AP at those scheduled times so that the STAs avoid sending duplicated requests to schedule a new wakeup time (note that in certain embodiments, the one or more STAs may be commonly synchronized with each other as part of the WWAN network, wherein the cell tower provides the synchronization function, while the AP is the one device that is out of synch).

When a STA (e.g., an AP) determines that the STA will be sending paging messages to groups of other STAs (e.g., STAs that have all negotiated TWTs at very similar times), the STA notifies (e.g., by sending an AID response element or container containing a list of identifiers that the STA can use for being paged) the other STAs of one or more group identifiers that the STA will use. That is, a STA planning to use a group identifier to address other STAs indicates this to the other STAs before using the group identifier.

According to aspects of the present disclosure, a STA may detect a paging message from a first WLAN using a first receiver during a wakeup period and power up (e.g. activate, power on) a second receiver, transmitter, and/or transceiver to communicate with a second WLAN in response to detecting the paging message. For example, a STA may detect a paging message from an IEEE 802.11 ah WLAN and activate a transceiver capable of communicating on a frequency in a 2.4 GHz frequency band and/or 5 GHz frequency band to communicate with an IEEE 802.11p, IEEE 802.11ac, or IEEE 802.11ad WLAN. In the example, the IEEE 802.11ah WLAN paging message may be an IEEE 802.11 WLAN beacon (e.g., an S1G beacon frame) containing 30 bytes of information, including a traffic indication map (TIM) element that may carry a traffic indication for each of up to eight STAs. That is, the exemplary STA may receive a page including a TIM indicating transmissions that the STA should receive, and the page may also include information for up to seven other STAs. According to aspects of the present disclosure, a STA may determine whether the STA is in range of a second WLAN (e.g., an IEEE 802.11ac WLAN) based on a signal strength metric (e.g., a reference signal strength indicator (RSSI)) of a first WLAN (e.g., an IEEE 802.11ah WLAN), and the STA may determine to activate a second receiver, transmitter, and/or transceiver to communicate with the second WLAN if the signal strength metric of the first WLAN is equal to or above a threshold.

According to aspects of the present disclosure, a STA may receive a paging messages from a WLAN that is a sub-one gigahertz (S1G) beacon. Additionally or alternatively, a STA may receive a paging message that is a null data packet (NDP) page. An NDP paging message may include an identifier (e.g. a P-ID field that contains a partial AID of a STA) or an identifier that is assigned to one or more STAs if the paging AP determines to page multiple STAs.

According to aspects of the present disclosure a STA may receive paging messages from a WLAN or a traffic indication map (TIM) including information for a plurality of STAs (e.g., 8191 STAs). It may also indicate whether there is multicast/broadcast traffic buffered at the AP if the paging message is a delivery traffic indication map (DTIM i.e., bit 0 of the TIM is 1 in this case).

According to aspects of the present disclosure, a STA may request a new or adjusted wakeup period (e.g., a TWT) from an AP to adjust for differences in system timing of a WLAN and a WWAN. For example, a STA may detect that clock drift of a WLAN AP has caused a TWT negotiated by the STA to no longer be aligned with wakeup periods used by the STA to monitor for paging messages from a WWAN, and the STA may request a new TWT from the WLAN AP that is aligned to the wakeup used by the STA to monitor for paging messages from the WWAN. In a second example, a STA may request a new TWT from an AP after a fixed number (e.g., ten) of paging-cycles of the AP, in order to maintain alignment between the TWT and wakeup periods of the WWAN.

A STA requesting a new wakeup period from an AP may sense the radio frequency (RF) medium to check whether the medium is occupied before transmitting the request. A STA requesting a new wakeup period may use a random time-offset within a wakeup period of the WWAN and reduce the possibility of colliding with a request for a new wakeup period being made by another STA. Additionally or alternatively, a STA requesting a new wakeup period may transmit the request after a randomly selected number of wakeup periods of the WWAN and reduce the possibility of colliding with a request for a new wakeup period being made by another STA.

According to aspects of the present disclosure, a STA may miss (e.g., fail to receive) paging messages from a WLAN. A STA may miss paging messages because the receiver of the STA is being utilized for a WWAN communication, because of bad channel conditions for the WLAN, or because of a discrepancy in timing between the WWAN, the WLAN, and the STA. According to aspects of the present disclosure, a STA that misses equal to or more than threshold a number (e.g., ten) of paging messages may transmit a null data packet (NDP) power save poll (PS-poll) to an AP of the WLAN. Upon receiving the NDP PS-poll from a STA, an AP may reply to the STA with an NDP acknowledgment (ACK). A STA transmitting an NDP PS-poll after missing the threshold number of paging messages may be referred to as failing over to transmitting the NDP PS-poll. That is, transmitting the NDP PS-poll to provoke an NDP ACK is part of a failsafe mechanism of the STA and the AP to improve reliability of the STA to AP connection.

According to aspects of the present disclosure, a STA may store and retrieve parameters regarding the wakeup periods of a WLAN and/or a WWAN in shared memory (e.g., memory that is shared between multiple receive processors and transmit processors).

According to aspects of the present disclosure, an AP may assign multiple STAs that request overlapping WLAN wakeup times (e.g., TWTs) to an identifier. Such an AP may then page the multiple STAs by including the identifier in a paging message. Additionally or alternatively, an AP may transmit multiple paging messages to multiple STAs sequentially in one wakeup period.

As previously described, a STA may transmit an NDP PS-poll to an AP. According to aspects of the present disclosure, an AP receiving an NDP PS-poll may reply to the NDP PS-poll with an S1G beacon, and NDP page, or a TIM broadcast frame.

According to aspects of the present disclosure an AP may include an information element (IE) in a paging message, indicating to the paged STA whether the AP supports the STA associating with the AP on multiple different channels. If the AP indicates in the paging message that the AP supports the STA associating with the AP on multiple different channels, then the STA may respond the paging message by associating on a WLAN on a different channel. For example, an AP may page a STA using an IEEE 802.11ah WLAN and include an IE indicating that the AP supports the STA connecting on multiple channels. In the example, the receiving STA may, according to aspects of the present disclosure, associate with the AP using an IEEE 802.11 ac WLAN. Still in the example, if the AP had indicated that the AP does not support the STA connecting on multiple channels, then the STA may respond by requesting a connection to the AP on the IEEE 802.11 ah WLAN.

According to aspects of the present disclosure, a STA may transmit a request, to an access point of a WLAN, for a maximum packet size to be used in communication with the STA via the WLAN. A STA may obtain data to be transmitted via a WLAN (e.g., an IEEE 802.11ah WLAN) and determine, based on the maximum packet size, to request transfer of a communication session from the WLAN to another WLAN (e.g., an IEEE 802.11ac WLAN) to transmit the data.

According to aspects of the present disclosure, a STA may determine, based on a data rate of communications with a WLAN over a period of time (e.g., 500 milliseconds) being equal to or above a threshold, to request transfer of a communication session from the WLAN to another WLAN (e.g., an IEEE 802.11n WLAN, an IEEE 802.11 ac WLAN) to transmit the data. When the STA requests the transfer of the communication session to another WLAN (e.g., an IEEE 802.11n WLAN, an IEEE 802.11ac WLAN), the STA also powers on (e.g., activates, wakes up) a transmitter, receiver, and/or transceiver that is able to communicate (e.g., able to transmit or receive on a 2.4 GHz or 5 GHz frequency band) with the other WLAN.

According to aspects of the present disclosure, a STA may determine, based on access latency of the WLAN being equal or above a threshold, to request transfer of a communication session from the WLAN to another WLAN (e.g., an IEEE 802.11n WLAN, an IEEE 802.1 lac WLAN) to transmit the data. When the STA requests the transfer of the communication session to another WLAN (e.g., an IEEE 802.11n WLAN, an IEEE 802.11ac WLAN), the STA also powers on (e.g., activates, wakes up) a transmitter, receiver, and/or transceiver that is able to communicate (e.g., able to transmit or receive on a 2.4 GHz or 5 GHz frequency band) with the other WLAN.

According to aspects of the present disclosure, a STA may determine, based on buffer-sizes at the STA, to request transfer of a communication session from the WLAN to another WLAN (e.g., an IEEE 802.11n WLAN, an IEEE 802.11ac WLAN) to transmit the data. When the STA is communicating on a WLAN that does not support a data throughput rate that is high enough for the STA, then data will accumulate in buffers at the STA, and the buffer-sizes will grow. The STA may then request transfer of one or more flows to a WLAN that supports a higher data throughput rate. When the STA requests the transfer of the communication session to another WLAN (e.g., an IEEE 802.11n WLAN, an IEEE 802.11ac WLAN), the STA also powers on (e.g., activates, wakes up) a transmitter, receiver, and/or transceiver that is able to communicate (e.g., able to transmit or receive on a 2.4 GHz or 5 GHz frequency band) with the other WLAN.

According to aspects of the present disclosure, a STA may identify one or more flows to transfer from a first WLAN to a second WLAN based on certain QoS parameters of the flows and then request transfer of the flows based on which flows the STA identifies as benefiting from moving to an IEEE 802.11n or IEEE 802.11ac WLAN. That is, if a STA identifies one or more flows that can benefit from a higher data rate, then the STA may send a request to a WLAN AP to transfer the identified flows to a WLAN with a higher available data rate.

According to aspects of the present disclosure, a STA may associate with one or more WLANs identify the STA with a media access control (MAC) address that is used to identify the STA to a WWAN. According to aspects of the present disclosure, use of a single MAC address by the STA may facilitate fast session transfers between a first WLAN and a second WLAN. For example, a STA may communicate with an LTE WWAN using a MAC address, and the STA may associate with an IEEE 802.11ah WLAN using the same MAC address and a same or different receiver. In the example, the STA may also associate with an IEEE 802.11ac WLAN using the same MAC address and a different receiver of the STA.

According to aspects of the present disclosure, a STA may communicate data of a voice call via a WLAN. That is, a STA may receive a page on a WLAN for a voice call, and use a WLAN transmitter, a WLAN receiver, and/or a WLAN transceiver to communicate data of the voice call with a WLAN AP. A STA operating according to these aspects may determine to communicate the data independent of a transmit power amplifier, if a signal strength metric of the WLAN is equal to or above a threshold. That is, a STA may determine that the STA is in good channel condition with the WLAN based on a signal strength metric, and the STA could then transmit data of a voice call without using a transmit power amplifier, allowing the STA to save power.

According to aspects of the present disclosure, a STA may detect a paging message from the WWAN in a wakeup period used by the STA for monitoring for paging messages from the WWAN and establish a voice call with the WWAN in response to the paging message. Gaps may be associated with a voice call, wherein the STA is transmitting or receiving data packets of the voice call during certain times while the call is occurring, but at other times while the call is occurring the STA is not transmitting or receiving data packets of the voice call. According to aspects of the present disclosure, a STA may communicate with a WLAN during gaps associated with a voice call while the voice call is ongoing. For example, a STA may establish a voice call with a WWAN. In the example, the STA may transmit a data packet of the voice call in a first period of one millisecond out of every twenty milliseconds, and the STA may receive, from the WWAN, a data packet of the voice call in a second period of one millisecond out of every twenty milliseconds. Still in the example, the STA may communicate other data packets (e.g., data packets not of the voice call) with a WLAN for a third period of five milliseconds out of every twenty milliseconds.

According to aspects of the present disclosure, a STA may include a second receive interface and a second receiver configured to obtain messages from a second WLAN. Such a STA may determine, based on a signal strength metric of a first WLAN being equal to or above a first threshold, whether to power up the second receiver. For example, a STA may include a first receive interface and first receiver configured to associate the STA with an IEEE 802.11ah WLAN. In the example, the STA also includes a second receive interface and second receiver configured to associate the STA with an IEEE 802.11ac WLAN. Still in the example, the STA may be associated with an IEEE 802.11ah WLAN, and may receive a paging message from the IEEE 802.11ah WLAN. Continuing the example, the STA may determine that a reference signal strength indicator (RSSI) of the IEEE 802.11ah WLAN is above a threshold amount, and the STA may activate the second receive interface and second receiver to associate the STA with an IEEE 802.11ac WLAN.

According to aspects of the present disclosure, a STA may include a second receive interface and a second receiver configured to obtain messages from a second WLAN. Such a STA may determine, based on an indication of high bandwidth or low latency data for the STA contained in a paging message detected based on the monitoring in the first WLAN, whether to power up the second receiver. High bandwidth low latency data may be indicated in a paging message by, for example, including an information element (IE) indicating the high bandwidth or low latency data in the paging message. For example, a STA may include a first receive interface and first receiver configured to associate the STA with an IEEE 802.11ah WLAN. In the example, the STA also includes a second receive interface and second receiver configured to associate the STA with an IEEE 802.11ac WLAN. Still in the example, the STA may be associated with an IEEE 802.11ah WLAN, and may receive a paging message from the IEEE 802.11ah WLAN that indicates that a high bandwidth communication session is to be established with the STA. Continuing the example, the STA may determine to activate (e.g., power up) the second receive interface and second receiver to associate the STA with an IEEE 802.11ac WLAN, based on the indication in the paging message.

According to aspects of the present disclosure, a STA may establish a communication session with a WLAN using a receiver and use the same receiver to monitor for paging messages in a WWAN. A STA operating in this manner may tune away from the WLAN frequency band to the WWAN frequency band during each paging-cycle of the WWAN, in order for the STA to monitor for paging messages in the WWAN.

According to aspects of the present disclosure, an AP may determine to transfer a communication session (e.g., a flow) with a STA from a first WLAN to a second WLAN. For example, an AP may determine that a streaming video session for a STA will be better served by an IEEE 802.11ac communication session than by an IEEE 802.11ah communication session, and the AP determines to transfer the streaming video session from an IEEE 802.11ah WLAN to an IEEE 802.11ac WLAN.

An AP may send a basic service set (BSS) transition management (BTM) to a STA when the AP determines to transfer a communication session with the STA from a first WLAN to a second WLAN. An AP may send a BTM to a STA to transfer a communication session to an IEEE 802.11n or IEEE 802.11ac WLAN. An AP may operate in such a manner that data flows are assigned to an IEEE 802.11ah WLAN for as long as the IEEE 802.11ah WLAN is able to support all of the data flows with sufficient data rate capacity.

An AP may send an operations and management network (OMN) command to a STA when the AP determines to transfer a communication session with the STA from a first WLAN to a second WLAN. An AP may send an OMN command to a STA to transfer a communication session to an IEEE 802.11n or IEEE 802.11ac WLAN.

According to aspects of the present disclosure, an AP may identify one or more flows to transfer from a first WLAN to a second WLAN, again based on QoS parameters of the flows, and send a BTM to transfer flows based on which flows the AP identifies as benefiting from moving to an IEEE 802.11n or IEEE 802.11ac WLAN. That is, if an AP identifies one or more flows that can benefit from a higher data rate, then the AP may send a BTM to transfer the identified flows to a WLAN with a higher available data rate.

According to aspects of the present disclosure, an AP may identify one or more flows to transfer from a first WLAN to a second WLAN using per-STA data rates. According to these aspects, if the data rate over a window (e.g., 500 ms) is above or equal to a threshold, an AP sends a BTM to move one or more flows to an IEEE 802.11n or IEEE 802.11ac WLAN.

According to aspects of the present disclosure, an AP may identify one or more flows to transfer from a first WLAN to a second WLAN using buffer-sizes at the AP. According to these aspects, if a buffer-size of one or more flows is above or equal to a threshold (e.g., due to backed up packets destined for one or more STAs), an AP sends a BTM to move the one or more flows to an IEEE 802.11n or IEEE 802.11ac WLAN.

According to aspects of the present disclosure, an AP may identify one or more flows to transfer from a first WLAN to a second WLAN using overall medium occupancy measured by the AP. According to these aspects, an AP may monitor the overall radio frequency (RF) medium occupancy for a WLAN and, if the medium occupancy is above or equal to a threshold, the AP sends a BTM to move one or more flows to an IEEE 802.11n or IEEE 802.11ac WLAN. An AP may operate in such a manner that data flows are assigned to an IEEE 802.11ah WLAN for as long as the IEEE 802.11ah WLAN is able to support all of the data flows with sufficient data rate capacity.

### Example Session Management Between Different WLANS

Aspects of the present disclosure may help transfer communication sessions between different WLANs. In some cases, a wireless wide area network (WWAN) modem (MDM) may support wireless local area network (WLAN) communications, such as IEEE 802.11ah. Additionally or alternatively, WLAN communications may be handled by a separate station WLAN (e.g., 2.4/5 GHz) access point (AP) (e.g., a system on chip (SoC)).

Techniques are desired for session transfer between a MDM supporting WLAN (e.g., IEEE 802.11ah) and a WLAN (e.g., a 2.4/5 GHz WLAN SoC). Such session transfer may enhance performance by providing seamless utilization of a second WLAN as an alternative or additional source of bandwidth.

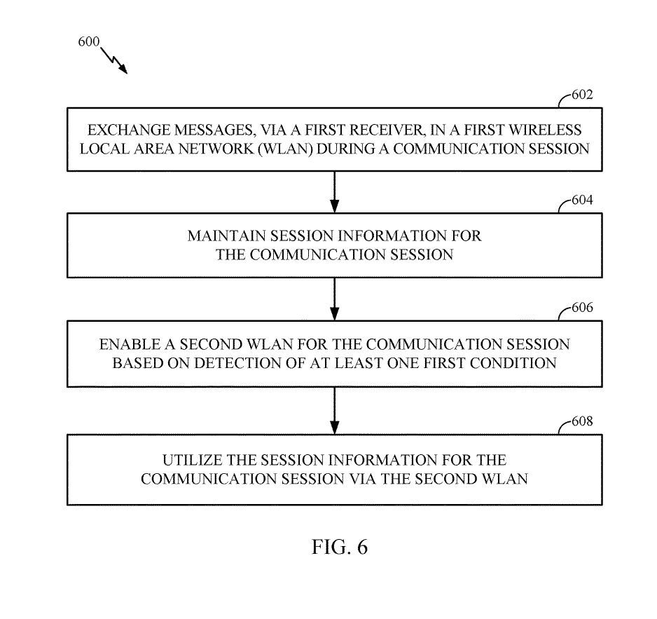

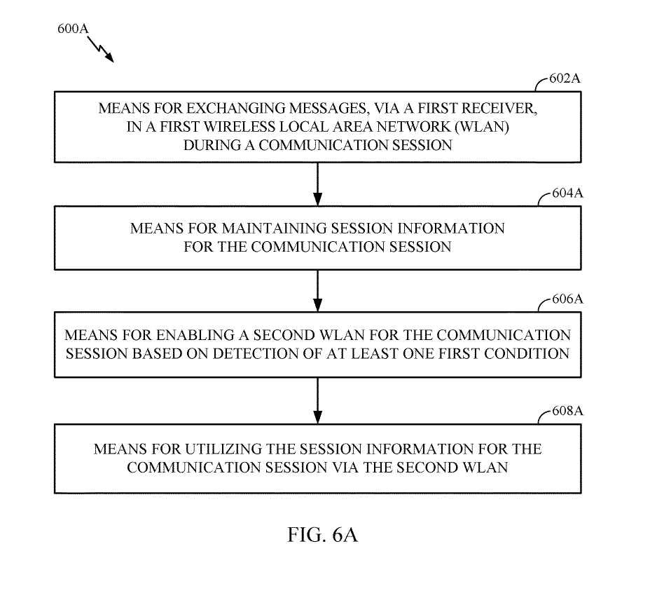

FIG. 6 illustrates example operations 600 for session management, for example, between a WWAN modem supporting WLAN (e.g., a IEEE 802.11ah WLAN) and a WLAN (e.g., a 2.5.5 GHz WLAN SoC), in accordance with certain aspects of the present disclosure. The operations 600 may be performed by a station capable of communicating via a WWAN and at least two WLANs (e.g., UT 120).

The operations 600 begin, at 602, by exchanging messages, via a first receiver, in a first WLAN during a communication session. At 604, information (e.g., session information) may be maintained for the communication session. As used herein, the term session information generally refers to state information kept in a pair of STAs that have an established direct PHY link.

The session information may include a virtual medium access control (MAC) identification (ID) and/or virtual client ID used in both the first and second WLANs to exchange messages in the second WLAN during the communication session.

At 606, a second WLAN may be enabled (e.g., by enabling a receiver) for the communication session based on detection of at least one first condition. For example, the first condition may include a receive signal strength of a paging message detected in the first WLAN being greater than or equal to a threshold value or detecting anticipated bandwidth of traffic for the communication session being greater than or equal to a threshold value.

According to certain aspects, the second WLAN may be disabled for the communication session based on detection of at least a second condition (e.g., a processing system may be configured to disable the second WLAN). The second condition may include a receive signal strength of a message detected in at least one of the first WLAN or the second WLAN being less than or equal to a threshold value or detecting anticipated bandwidth of traffic for the communication session being less than or equal to a threshold value.

At 608, the information may be utilized for the communication session via the second WLAN. According to certain aspects, both the first and second WLANs may be used simultaneously for the communication session. For example, the first WLAN may be used for a first set of one or more flows and the second WLAN for may be used for a second set of flows.

FIG. 7 illustrates example architecture 700 for session management by a device (e.g., a STA) configured to communicate via one or more WLANs and a WWAN, in accordance with certain aspects of the present disclosure.

As shown in FIG. 7, the STA may include a WWAN modem (MDM) which may also support WLAN, such as WLAN 1 (e.g., for IEEE 802.11ah communications), an operating system (e.g., IOS, Android, etc.), and a WLAN AP (e.g., a system on chip (SoC)) for communicating with a WLAN 2 (e.g., a 2.4/5 GHz WLAN).

As shown in FIG. 7, a communication session may be transferred between the 11ah WLAN AP and the 2.5/5 GHz WLAN AP. For example, for short range (e.g., high receive signal strength indicator (RSSI)) communications or high bandwidth communications, the session may be transferred to the 2.4/5 GHz WLAN SoC, while long range (e.g., low RSSI) communications, low bandwidth communications, or if the WLAN SoC is entering deep sleep, the session may be transferred to the 11ah WLAN AP on the MDM.

According to certain aspects, IP continuity may be maintained during session transfer (e.g., between IEEE 802.11ah WLAN and 2.5/5 GHz WLAN SoC). For example, an operating system (e.g., IOS, Android, etc.) may maintain a same virtual medium access control (MAC) ID or a same Client-ID (e.g., in a dynamic host configuration protocol (DHCP) Request).

In some cases, (modules supporting) the different WLANs may not directly exchange information. The WLANs may be separate modules, for example, on different ICs (system on a chip or SOC). For example, the IEEE 802.11ah WLAN module may be on the modem while the 2.4/5 GHz WLAN module may be on a separate SOC. The operating system may facilitate all of the information to make the decision for session transfer.

According to certain aspects, operations over the WLANs (e.g., 11ah and 2.4/5 GHz) may be simultaneous or non-simultaneous. As illustrated in FIG. 9, in some cases Fast session transfer (FST) may provide for fast switching between bands to address user mobility, dynamic channel conditions, and joint management of multiple bands. FST generally refers to the transfer of a session from one physical channel to another channel when the communicating STAs both have matching radios in the frequency band they wish to communicate. The FST may utilize a bonding driver, providing data switch control for session transfer between WLANs. While the illustrated example shows two WLANs, WLAN0 (2.4/5 GHz) on an SoC and WLAN1 (11ah supported by a modem), aspects of the present disclosure may be expanded to transfer sessions between more than 2 WLANs.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 600 illustrated in FIG. 6, respectively, correspond to means 600A illustrated in FIG. 6A.

The exemplary means 600A includes means 602A for exchanging messages, via a first receiver, in a first WLAN during a communication session. Means for exchanging messages 602A may include, for example, a transmitter (e.g., the transceiver front end 254a through 254r of the user terminal 120 depicted in FIG. 2 or the transceiver front end 232a through 232t of the access point 110 shown in FIG. 2) and/or an antenna (e.g., the antennas 252a through 252r of the user terminal 120 shown in FIG. 2 or the antennas 232a through 232t of the access point 110 shown in FIG. 2) or a receiver (e.g., the transceiver front end 254a through 254r of the user terminal 120 depicted in FIG. 2 or the transceiver front end 232a through 234t of the access point 110 shown in FIG. 2) and/or an antenna (e.g., the antennas 252a through 252r of the user terminal 120 shown in FIG. 2 or the antennas 232a through 232t of the access point 110 shown in FIG. 2).

The exemplary means 600A includes means 604A for maintaining session information for the communication session, means 606A for enabling a second WLAN for the communication session based on detection of at least one first condition, and means 608A for using the session information for the communication session via the second WLAN. Means for maintaining 604A, means for enabling 606A, means for using 608A, means for disabling, means for simultaneously using, and/or means for detecting may include, for example, a processing system (e.g., TX MIMO Processor 230, Schedule 246, Receive Processor 238, Controller/Processor 240, Transmit Processor 220, or combinations thereof, of the access point 110 shown in FIG. 2 or TX MIMO Processor 266, Transmit Processor 264, Controller/Processor 280, Receive Processor 258, or combinations thereof, of the user terminal 120 shown in FIG. 2).

According to certain aspects, such means may be implemented by processing systems configured to perform the corresponding functions by implementing various algorithms (e.g., in hardware or by executing software instructions) described above for performing fast association.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for exchanging messages in a first WLAN during a communication session, instructions for maintain session information for the communication session, instructions for enabling a second WLAN for the communication session based on detection of at least one first condition, and instructions for using the session information for the communication session via the second WLAN.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
at least one interface configured to exchange messages, via a first receiver, in a first wireless local area network (WLAN) during a communication session; and
a processing system configured to:
maintain information for the communication session,
enable a second WLAN for the communication session based on detection of at least one first condition, and
use the information for the communication session via the second WLAN.

2. The apparatus of claim 1, wherein the processing system is configured to enable a second receiver for the communication session via the second WLAN.

3. The apparatus of claim 1, wherein the at least one first condition comprises a receive signal strength of a message detected in the first WLAN being greater than or equal to a threshold value.

4. The apparatus of claim 3, wherein the message comprises a beacon message, data message, paging message, or an acknowledgment message.

5. The apparatus of claim 1, wherein the at least one first condition comprises detecting anticipated bandwidth of traffic for the communication session being greater than or equal to a threshold value.

6. The apparatus of claim 1, wherein the processing system is further configured to disable the second WLAN for the communication session based on detection of at least a second condition.

7. The apparatus of claim 6, wherein the second condition comprises a receive signal strength of a message detected in at least one of the first WLAN or the second WLAN being less than or equal to a threshold value.

8. The apparatus of claim 6, wherein the second condition comprises detecting anticipated bandwidth of traffic for the communication session being less than or equal to a threshold value.

9. The apparatus of claim 1, wherein:
the information comprises a virtual medium access control (MAC) identification (ID) used in both the first and second WLANs.

10. The apparatus of claim 1, wherein:
the information comprises a virtual client identification (ID) for the apparatus used in both the first and second WLANs; and
the processing system is configured to use the virtual client ID to exchange messages in the second WLAN during the communication session.

11. The apparatus of claim 1, wherein the processing system is configured to simultaneously use both the first and second WLANs for the communication session.

12. The apparatus of claim 11, wherein the processing system is configured to use the first WLAN for a first set of one or more flows and to use the second WLAN for a second set of flows.

13. A method for wireless communications, comprising:
exchanging messages, via a first receiver, in a first wireless local area network (WLAN) during a communication session;
maintaining session information for the communication session,
enabling a second WLAN for the communication session based on detection of at least one first condition, and
using the session information for the communication session via the second WLAN.

14. The method of claim 13, wherein enabling the second WLAN for the communication session comprises enabling a second receiver for the communication session via the second WLAN.

15. The method of claim 13, wherein the at least one first condition comprises a receive signal strength of a message detected in the first WLAN being greater than or equal to a threshold value.

16. The method of claim 15, wherein the message comprises a beacon message, data message, paging message, or an acknowledgment message.

17. The method of claim 13, wherein the at least one first condition comprises detecting anticipated bandwidth of traffic for the communication session being greater than or equal to a threshold value.

18. The method of claim 13, further comprising disabling the second WLAN for the communication session based on detection of at least a second condition.

19. The method of claim 18, wherein the second condition comprises a receive signal strength of a message detected in at least one of the first WLAN or the second WLAN being less than or equal to a threshold value.

20. The method of claim 18, wherein the second condition comprises detecting anticipated bandwidth of traffic for the communication session being less than or equal to a threshold value.

21. The method of claim 13, wherein:
the information comprises a virtual medium access control (MAC) identification (ID) used in both the first and second WLANs.

22. The method of claim 13, wherein:
the information comprises a virtual client identification (ID) for the apparatus used in both the first and second WLANs; and
the method further comprises using the virtual client ID to exchange messages in the second WLAN during the communication session.

23. The method of claim 13, comprising simultaneously using both the first and second WLANs for the communication session.

24. The method of claim 23, wherein the simultaneous using comprises using the first WLAN for a first set of one or more flows and using the second WLAN for a second set of flows.

25. An apparatus for wireless communications, comprising:
means for exchanging messages, via a first receiver, in a first wireless local area network (WLAN) during a communication session;
means for maintaining information for the communication session,
means for enabling a second WLAN for the communication session based on detection of at least one first condition, and
means for using the information for the communication session via the second WLAN.

26-37. (canceled)

38. A wireless station, comprising:
a first receiver configured to exchange messages in a first wireless local area network (WLAN) during a communication session; and
a processing system configured to:
maintain information for the communication session,
enable a second WLAN for the communication session based on detection of at least one first condition, and
use the information for the communication session via the second WLAN.

39. The wireless station of claim 38, wherein
the processing system is configured to enable a second receiver for the communication session via the second WLAN; and
the second receiver is located on a different integrated circuit than the first receiver.
